(19) United States
(12) Patent Application Publication
(10) Pub. No.: US 2008/0065458 A1
(43) Pub. Date: Mar. 13, 2008

(54) METHOD AND SYSTEM FOR REDUCING TOTAL TRANSACTIONAL LEAD TIME AND ENHANCING QUALITY OF A PROCESS WITHIN A HEALTHCARE ENVIRONMENT

(75) Inventors: Ronald R Sullivan, Oconomowoc, WI (US); John R Tjahjadi, Oconomowoc, WI (US)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/531,413

(22) Filed: Sep. 13, 2006

(51) Int. Cl. G06F 9/46

(52) U.S. Cl. 705/9

(57) ABSTRACT

A method of implementing a procedural change to a step of process executed by a plurality of personnel is provided. The method comprises the acts of requesting and recording at least one operational owner of the process, requesting the at least one operational owner to invite a series of personnel to implement a procedural change that enhances the process, requesting and recording a stakeholder analysis that includes a score representative of a commitment of each of the series of personnel to implementing the procedural change, identifying at least one stakeholder from the series of personnel to lead implementing the procedural change based on the score of the stakeholder analysis, and creating and implementing the procedural change to the process.

### BACKGROUND OF THE INVENTION

This subject matter generally relates to a method and system for enhancing a process, and more specifically, a method and system for enhancing a process employed in the healthcare environment.

The healthcare environment can include numerous types of processes, including but not limited to admissions, medical diagnosis treatment, transactional management, construction management, data management, etc. Each of the processes can be comprised of smaller processes, which can be further broken down into even smaller processes.

However, typical processes employed by in the healthcare environment have drawbacks. Technology has advanced rapidly in the past thirty to forty years, especially in the area of digitization. However, typical services performed by generally large-scale healthcare providers and vendors are performed by cross-operational yet segregated groups of personnel that interact on an infrequent basis, sustaining a reluctance to change. This reluctance to change maintains an increased likelihood of error, a large demand for rework, and reduced capacity of our healthcare institutions. Also, healthcare institutions that attempt change typically look to quick fix tools that over time are not sustained and eventually dropped for old practices.

Accordingly, there is a desire for method and system to drive change to enhance quality and reduce end-to-end cycle-time of services provided in a health-care environment, and then to drive sustaining the change into the future.

### BRIEF DESCRIPTION OF THE INVENTION

The above-mentioned shortcomings, disadvantages and problems are addressed by the embodiments described herein in the following description.

In one embodiment, a method of implementing a procedural change to a set of processes executed by a plurality of personnel is provided. The method comprises the acts of requesting and recording at least one operational owner of the process, requesting at least one operational owner to invite a series of subject matter expert personnel to implement a procedural change that enhances the process, requesting and recording a stakeholder analysis that includes a score representative of a commitment of each of the series of personnel to implementing the procedural change, identifying at least one stakeholder from the series of personnel to lead implementing the procedural change based on the score of the stakeholder analysis, creating and implementing the procedural change to the process.

In another embodiment, a system for enhancing a process is provided. The system includes a computer in communication with display. The computer includes a processor operable to execute a plurality of program instructions stored in a memory. The plurality of program instructions include performing the acts of requesting and recording at least one operational owner of the process, requesting at least one operational owner to invite a series of personnel to implement a procedural change that enhances the process, requesting and recording a stakeholder analysis that includes a score representative of a commitment of each of the series of personnel to implementing the procedural change, identifying at least one stakeholder from the series of personnel to lead implementing the procedural change based on the score of the stakeholder analysis, creating and implementing the procedural change to the process.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic diagram of an embodiment of a method of implementing a procedural change to process executed by a plurality of personnel.

FIG. 2 shows a schematic diagram of an embodiment of a computer system operable for implementing a method of reducing the process time and enhancing the quality of a process.

FIG. 3 illustrates an embodiment of a value stream map that can be utilized to illustrate a system wide view of the process.

FIG. 4 illustrates a schematic diagram of an embodiment of an act of identifying one or more goal(s) or objective statements for reducing total process cycle-time and enhancing quality of a process.

FIG. 5 shows an embodiment of a cause and effect diagram employed to define and record a problem and objective statement.

FIG. 6 shows an embodiment of an act of bounding an objective statement using a storybook technique.

FIG. 7 shows another embodiment of an act of bounding an objective statement using a frame technique.

FIG. 8 illustrates an embodiment of a tracking plan employed in sustaining a procedural change to process into the future.

### DETAILED DESRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

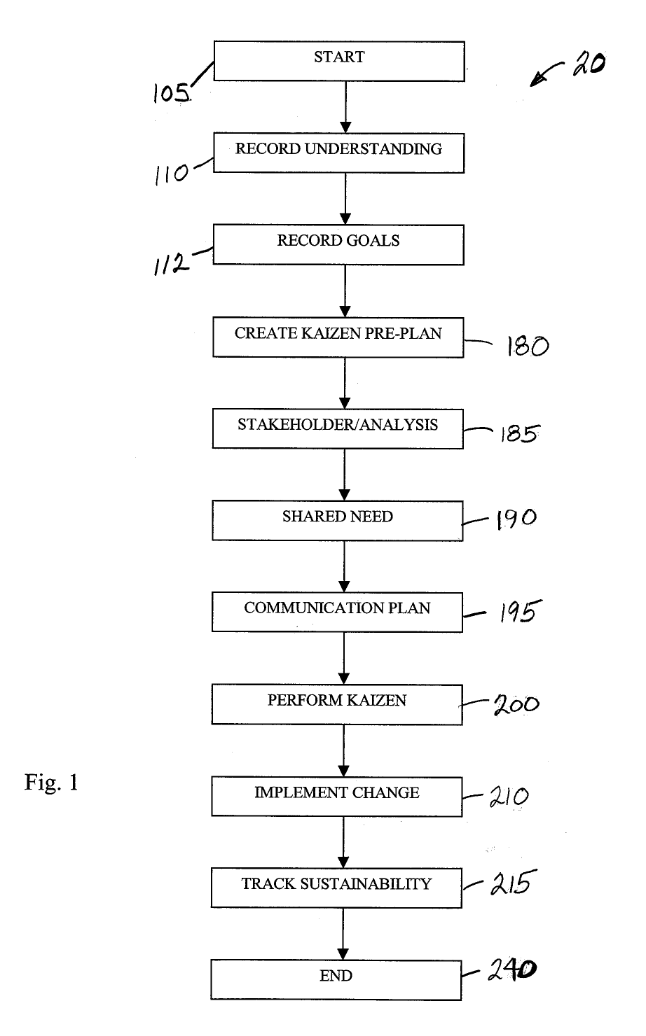

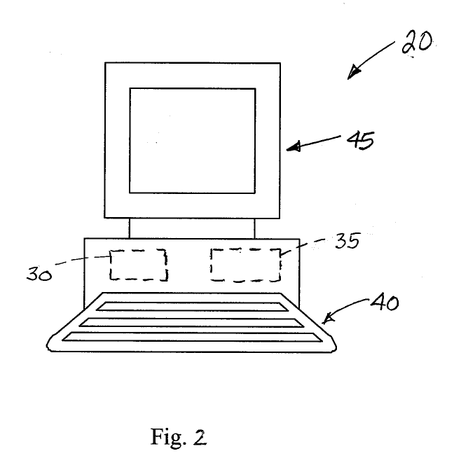

FIG. 1 generally illustrates an embodiment a method 20 of reducing the total process cycle-time time and enhancing the quality of the process operable to be implemented by a computer system 25 as illustrated in FIG. 2. Although the method 20 and computer system 25 are described with reference to the process in a medical or health environment, the type of process can vary (e.g., industrial setting, commercial setting, etc.) and is not limiting on the invention.

Referring specifically to FIG. 2, the computer system 25 generally includes a processor 30 in communication with a memory 35. The processor 30 is generally operable to execute a plurality of programming instructions stored in the memory 35. The memory 35 can include any conventional storage medium (e.g., hard-drive, memory stick, CD, DVD, etc.) used to store programming code.

The computer system 25 further includes an input 40 and an output 45. The input 40 can include a keyboard, a touch-screen, toggle switches, etc. or combination thereof used in a conventional manner to communicate an instruction or a data to the computer system 25. The output 45 can include a monitor (e.g., LCD, plasma, cathode tube), light emitting diodes (LEDs), a touch-screen, printer or other conventional display device or combination thereof operable to guide a user through the method 20.

FIG. 1 illustrates an embodiment of the method 20 represented by the plurality of programming instructions for execution by the processor 30 of the computer system 25 described above. Although the method 20 is described with reference to a description of acts, it is understood that the sequence of acts can vary and is not limiting. Also, it should be understood that the method 20 can comprise less or additional acts and is not limiting.

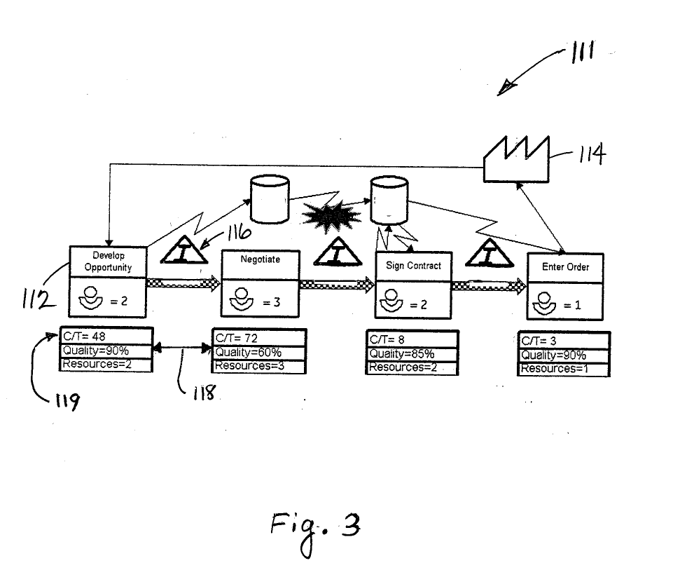

Act 105 is generally a start of the method 20. Act 110 generally includes developing and recording an understanding of the process to be improved through the collection of observational data including: detailed process step analysis, tracking value add and non-value added time, quantification of inventory build up, abnormality frequency and type, root cause for abnormality and classification/quantification of waste. The process to be improved is selected from customer-oriented processes detailed in the system level Value Stream Map (FIG. 3) and is expected to have a greatest impression with a customer. An example of customer-oriented processes include new product introduction, inquiry to order a service or product, and an order to remittance of a service or product.

An example of the act 110 of developing and recording an understanding of the process includes creating a value stream map 111 of the process, as illustrated in FIG. 3. The value stream map 111 is generally observational data at a complete systems level that illustrates of consecutive steps or processes, quantifies inventory, cycle-time, lead-time, details information flows, outlines resources allocations, and quantifies system level FPY (first pass yield) along with indicating whether the steps add value or don't add value (i.e., non-value), from start to finish of the process. The add value steps are generally those steps, activities, materials, etc. that a customer is willing pay for, that are necessary to manufacture a product or to provide a service, or that change the form, fit, or function of a step or part. Non-value added steps are those that do not add value as described above. By identifying and recording this information, the value stream map 111 provides a system level diagnostic tool that documents a current state of the system as a basis for developing a future state of the process, as well as identifies opportunities for improvement. More specifically, the value stream map 111 identifies how value flows to a customer, illustrates where flow stops and inventory builds, shows relationships or linkages between steps, and illustrates the location of waste in the process.

Referring to FIG. 3, the value stream map 111 generally includes a flow diagram comprised of a series of process boxes 112 that represent consecutive process steps (e.g., develop opportunity, negotiate, sign contract, and enter order) in processing an inquiry to order of a service or product by a customer 114. Each process box 112 can illustrate an indication of a number of personnel to perform the step, and an indication of the quality of performance of the process step. The value stream map 111 can further include an indication of an amount of inventory 116 waiting in queue between process steps, a lead time 118 between process steps, and a process or cycle time (C/T) 119 to complete each process step. The value stream map 111 can further include a calculation of a TAKT time generally equal to a total available work time per shift divided by a customer demand requirement per day for the shift. Of course, the above-described embodiment of the value stream map 111 is not limiting.

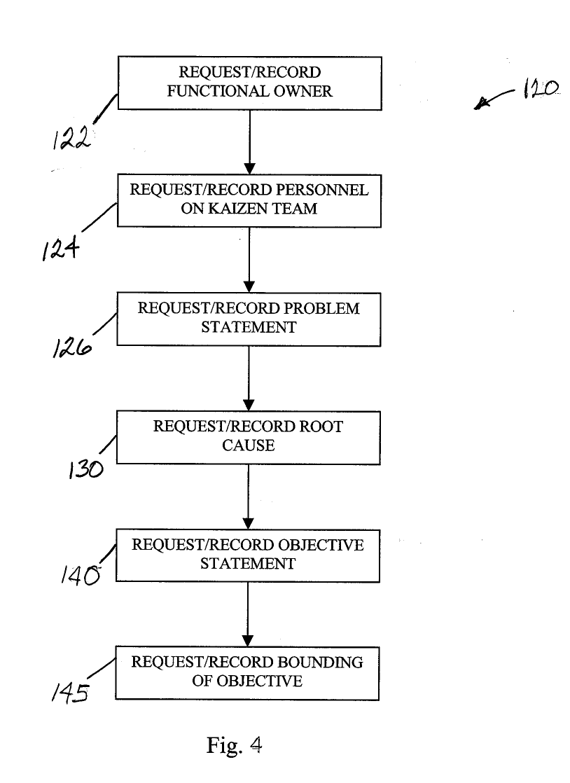

Referring back to FIG. 1, act 120 includes identifying and recording one or more goal(s) or objective statements for reducing process time and enhancing quality of the process. FIG. 4 illustrates an embodiment of act 120. Act 122 includes requesting and recording at least one operational owner of the one or more goal(s) for the process. An operational owner is defined as a functional leader with responsibility for a designated business unit. Act 124 includes requesting the functional owner to invite and record a series of personnel designated to participate on a kaizen team. The kaizen team will participate in a team-oriented kaizen activity intended develop, execute, and sustain a procedural change that enhances the process (e.g., reduces lead and/or cycle times and/or enhances quality).

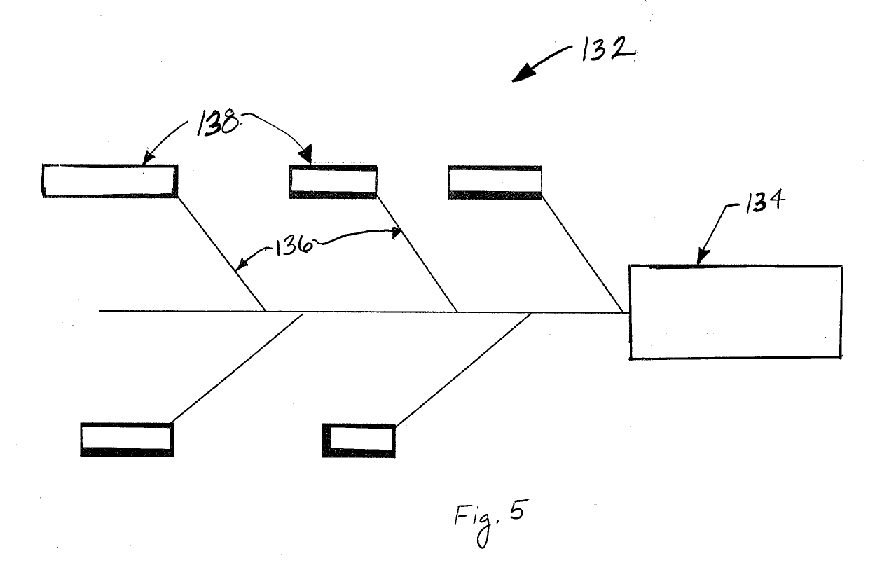

Still referring to FIG. 4, act 126 includes requesting that the operational owner(s) define and record a problem statement for the process. Act 130 includes identifying and recording a root cause of the problem statement utilizing lean tools and methodology, such as a Process Balance Chart, 5 Y's (i.e., method that includes asking five successive “why” questions), or Cause & Effect diagrams. For example, the act 130 can include creating and recording a bar type chart that illustrates where which processes have a total process time that exceeds the TAKT time described above, and what portion of the total process time is spent on a value-added step versus a non-value step as described above. FIG. 5 illustrates another example of the act 130 that includes creating and recording a cause and effect diagram 132 to define and record a problem statement 134. The cause and effect diagram 132 employs a “fish-bone” or “ishikawa” technique to identify and illustrate a link 136 of a series of causes 138 to the problem statement 134.

Referring back again to FIG. 1, act 140 includes requesting and recording an objective statement of the kaizen team to address the root cause of problem statement. An example of the objective statement is to get the cycle-time of each process down below TAKT time to allow leveling of workflow that will reduce the overall system level cycle-time.

Act 145 includes requesting and recording a boundary of the objective statement of the kaizen activity. One example of the bounding act 145 generally includes defining and recording what steps of the process are within and excluded from kaizen activity. Another example of the bounding act 145 can include illustrating the boundaries of what, who, when, where and time to be included in and excluded from the kaizen activity.

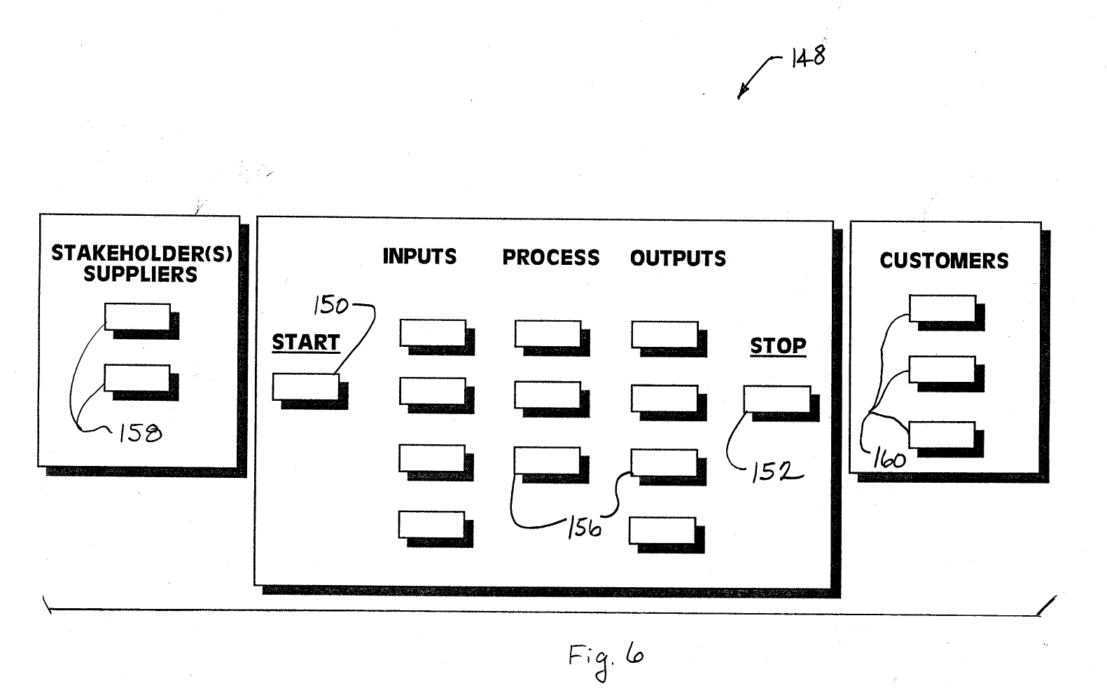

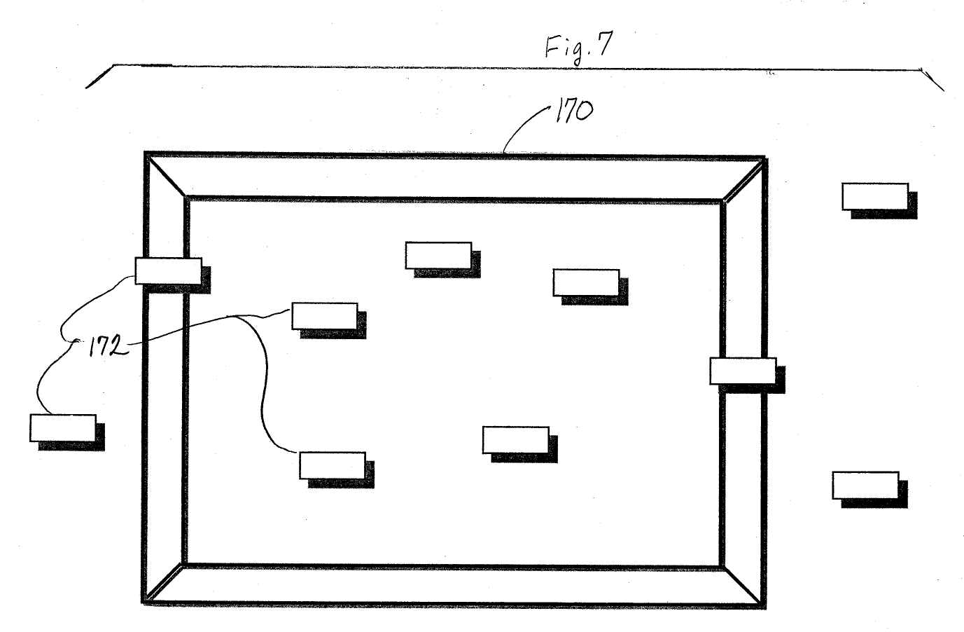

FIG. 6 illustrates an embodiment 148 of the bounding act 145 that includes employing a storyboarding technique in identifying and recording the first and last steps 150 and 152 from value stream mapping (similar to the value stream map 111 of FIG. 4) in addition to a series of steps 156 of the process there between to further identify the boundary of the kaizen activity, and identifying and recording those steps 158 and 160 performed by the supplier or by the customer, respectively, that are not part of the kaizen activity. FIG. 7 illustrates another embodiment 166 of the bounding act 145 that includes displaying a large frame 170 as representative of the kaizen activity, and attaching slips, flags, or notes 172 indicative of process steps that are adhered within the frame 170 or adhered outside the frame 170. These slips 172 can alternatively be indicative of type and extent of end results, people impacted, timeframe, product lines, sites, etc. The bounding act 145 can also utilize an alignment technique that includes each team member writing (e.g., in 15 words or less) a project definition for illustration to others of the team, identify any unclear terms, identify common terms and phrases, and then draft a common statement of the objective of the kaizen activity. The bounding act 145 can further include generating and sorting critical to success factors (CSFs) or major milestones/indicators of progress for the objective statement to be achieved. An example of CSFs can include, but is not limited to, identifying must-dos and must-haves of success, key measurements, and an identification of critical support personnel including systems and structure.

Referring back to FIG. 1, act 180 includes creating and recording a pre-plan for a kaizen activity. The act 180 of creating and recording the pre-plan can include recording the problem statement and the objective statement for the kaizen team to address in the kaizen activity, listing personnel on the kaizen team, roles and level of expertise, determining and identifying additional Lean Sensei's to participate on the kaizen activity, displaying the portion of the value stream map identified in the bounding act to be included and excluded from the kaizen activity, notifying organizations that are or may be affected by the kaizen activity, illustrating the name of the at least one operational owner, detailing the pre-planning data collection that is needed, and illustrating a location and needed supplies for the kaizen activity. The act 180 of creating and recording the kaizen pre-plan can further include identifying and recording an expected impact of the kaizen activity on pricing, revenue, billing, invoicing, policies, allocation of assets, credit worthiness, etc. that may affect reporting requirements in accordance with government regulations (e.g., Sarbanes Oxley Act under the Securities and Exchange Commission (SEC)).

Act 185 includes requesting at least one operational owner to identify and record at least one stakeholder as a kaizen team leader from the series of personnel on the kaizen team. The act 185 can include requesting and recording a resistance analysis. An example of the risk analysis includes requesting and recording a cultural analysis of the personnel, including identifying causes/reasons for resistance (e.g., technical, political, cultural) to the objective statement, systems and organizational structure analysis, and assigning a rating to each cause/reason for resistance as part of the total resistance on a scale of 0-100 percent. The act 185 can also include requesting and recording a stakeholder analysis of one or more of the series of personnel to determine commitment to the objective statement. The stakeholder analysis can include identifying and recording each personnel's actual commitment to the objective statement as either strongly against, moderately against, neutral, moderately supportive or strongly supportive. Of course, other types of measurement scales (e.g., numerical, etc.) can be use. The act 185 can further include comparing the actual commitment to a desired commitment of the personnel to the objective statement, illustrating how personnel are influentially linked to one another, and identify and record action steps to close a gap between indicated and desired commitment. Using these above-described tools, the operational owner can select one or more of the personnel on the kaizen team having a score indicative of least resistance and/or greatest commitment as the at least one stakeholder of the objective statement.

Act 190 includes creating and recording a shared need for the objective statement and procedural change. The act 190 can generally enhance commitment to agree that the objective statement is valuable to work toward at the time. An example of the act 190 can also include supplementing the resistance analysis as described above in the act 185 by requesting and recording a strategy for reducing resistance of all stakeholders below a neutral rating. The act 190 can include enhancing the stakeholder analysis as described above in the act 185 by identifying and recording a strategy for influencing greater commitment from the personnel on the kaizen team. Another example of the act 190 includes creating a matrix that illustrates comparison of identified threats to commitment versus identified opportunities enhancing commitment on a short term and long term basis to the objective statement. The act 190 can also include identifying and recording internal and external sources of information that are at hand and that are needed; examples of changes and best practices that are working and not working at other organizations; and sources (e.g., leadership, regulatory, or quality improvement, etc.) that are driving the changes at other organizations. The act 190 can further include identifying desired and undesired behaviors that may affect the objective statement. The act 190 can still further include identifying and recording threats and concerns that may limit commitment, as well as interests driving commitment to the objective statement. The act 190 can yet further include communicating an elevator speech to the at least one stakeholder and/or the kaizen team and/or the organization that clearly and simply sells the need for change and how the change is linked to the future state of the value stream map 111 and/or the organization.

Act 195 includes requesting and recording a plan to communicate the objective statement and pre-plan to the kaizen team. The act 195 includes identifying and recording the target audience, including any new stakeholders or personnel. The act 195 can also include identifying and recording a message to the audience, a mode of communication (e.g., written, video, one-on-one dialogue, etc.), identifying the person communicating, and identifying the when and where to communicate the objective statement, kaizen-plan, and miscellaneous logistics of the kaizen activity to the audience. The act 195 can still further include reviewing and revising the value stream map 111 and the kaizen pre-plan for the kaizen activity, and identifying and training the personnel on the kaizen tools to be employed in the kaizen activity. The tools can include basic six sigma tools and/or lean tools and principles employed in a conventional manner to reduce waste and enhance quality of the process. Thereby, the kaizen team is prepared to begin and execute the kaizen activity. Additionally, all observational information collected during pre-plan is presented along with the root cause analysis to ground the kaizen team in the direction to make the necessary change.

Act 200 includes performing the kaizen activity so as to create and record a procedural change to achieve the objective statement. The act 200 can include applying one or more lean tools/principles and or six sigma tools to at least one of the plurality of consecutive activities within the bounding of the problem statement to drive a procedural change to the process, and continually test and try-storm (i.e., continuing to iterate the solution idea while in test) whether the procedural change meets the objective statement and is a success. Kaizen activity is structured such that the team is initially trained in lean principles, grounded in the problem through complete process/system observation in the actual Gemba (eg. factory floor or process area where work is performed) where the problem exists. This is followed by determining the best method for solving the root cause of the issues driving the extended cycle-time or low quality. An example of a tool that can be used is 7-ways. To utilize this tool, the team breaks up into sub-groups, each assigned a root cause. Each member of the sub-team then writes down 7 different process methods for solving the root cause of the problem. The sub-team then discusses each of the team members 7-ways and determines which is the best method to follow or pulls several elements from each to build the complete solution to the root cause of the problem. Solutions are driven towards but not limited to standard work, single piece flow, first-in-first-out (FIFO), 5S (sort, set in order, shine, standardize, sustain), just in time flow, Heijunka (level processing or production), Jidoka (ie visual management, andon, do-check . . . ) and poke yoke (error proofing). Following the determination of the method to solve the problem, the team then tests the solution through the tri-storming process. This requires the solution to be implemented fully within the actual process environment. Results are determined during each test and adjustments are made on the spot and then re-tested. This process goes on until the desired outcome is attained. Then the complete change is implemented prior to the team disbanding with no or very few actions items left to be accomplished.

Act 210 includes implementing the procedural change to the process. The act 210 can include creating and communicating the procedural changes to all of the line employees along with the method of implementation. The act 210 can further include communicating an elevator speech that sells the procedural change to all direct line employees. Additionally, visual management should be implemented to drive daily-sustained change and to call out the occurrence of abnormalities to ensure a fix is implemented on the spot. Examples of visual management include but are not limited to production boards, hour by day charts, real-time process metric boards . . . ).

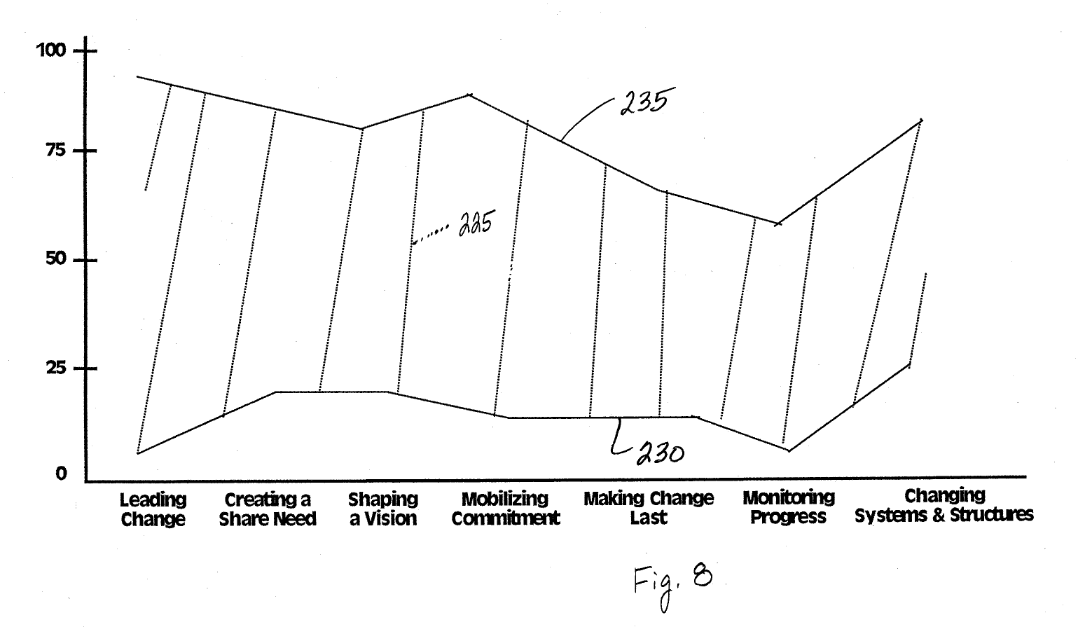

Act 215 includes requesting at least one stakeholder to create and record a tracking plan to verify and illustrate continuance or sustainability of the act of implementing the procedural change to the process. The 215 can include creating and communicating a detailed analytical process control report indicative of how well the procedural change is working, and requesting and recording any suggested additional changes to the procedural change. The act 215 can also include recording changes to the measures of the various parameters employed in the resistance analysis described above in act 185, and a strategy to reduce resistance into the future. The act 215 can also include requesting and recording changes to the measures of the parameters employed in the resistance analysis and/or the stakeholder analysis of commitment as described above in act 185, and the strategy to reduce resistance and/or enhance commitment for the procedural change into the future. The act 215 can still further include performing periodic audits to verify implementation of the procedural change and testing. FIG. 8 illustrates an embodiment 220 of the act 215 that includes illustrating a gap 225 between a measured commitment 230 and a desired commitment 235 from the personnel or stakeholders leading and sustaining the procedural change into the future, in creating shared need, in shaping a vision, in mobilizing commitment, in making change last, in monitoring progress, and in changing systems and structures as measured on a scale (e.g., 0-100%).

Act 215 can further include creating and recording a checklist to be completed on a periodic basis by the at least one operational process owner into the future. The act 215 can further include obtaining a signature from the at least one stakeholder verifying ownership and completion of the checklist. Act 240 is the end of the method 20.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of implementing a procedural change to a step of process executed by a plurality of personnel, the method comprising the acts of:
requesting and recording at least one operational owner of the process;
requesting the at least one operational owner to invite a plurality of personnel to create a procedural change that enhances the process;
requesting and recording a stakeholder analysis that includes a score representative of a commitment of each of the plurality of personnel to implement the procedural change;
identifying at least one stakeholder to lead implementing the procedural change based on the score of the stakeholder analysis; and
creating and implementing the procedural change to the process.

2. The method of claim 1, further comprising the acts of:
creating and displaying a value stream map that illustrates a measure of the complete system cycle-time and quality roll throughput yield (RTY) to perform each of a plurality of consecutive steps comprising the process; and
identifying an objective to reduce the cycle time and drive process quality of one or more of the plurality of consecutive steps of the initial value stream.

3. The method of claim 1, further comprising the act of bounding the objective, including identifying and recording one or more of the plurality of steps that are within a boundary of the objective, and identifying and others of the plurality steps that not within the boundary of the objective.

4. The method of claim 1, further comprising the act of requesting at least one stakeholder to communicate the objective to the plurality of personnel.

5. The method of claim 1, wherein the act of creating the procedural change includes:
identifying at least one root cause of an identified problem of the process, applying at least one lean six sigma tool to reduce a cycle time and drive process quality of at least one of the plurality of steps within the objective, and testing, reporting and implementing an effect of the procedural change relative to the objective.

6. The method of claim 1, further comprising the acts of:
implementing the program in the process;
requesting at least one stakeholder to create a detailed process control tracking plan operable to verify a continuance of the act of implementing the program for illustration on a visual display; and
illustrating the tracking program to the plurality of personnel.

7. The method of claim 6, wherein the tracking plan includes a checklist, and further comprising the act of obtaining a signature of at least one stakeholder indicating ownership and completion of the checklist.

8. The method of claim 1, further comprising the act of:
illustrating a name of the at least one operational stakeholder of the objective on a visual display for viewing by the plurality of personnel.

9. The method of claim 1, wherein the stakeholder analysis includes requesting and recording

10. The method of claim 1, wherein the tracking program includes requesting and recording a post-stakeholder analysis after the step of creating and implementing the procedural change.

11. A system for enhancing a process having at least one critical to quality characteristic, comprising:
a computer in communication with display, the computer having a processor operable to execute a plurality of program instructions stored in a memory, the plurality of program instructions including:
requesting and recording at least one operational owner of the process;
requesting at least one operational owner to invite a plurality of personnel to create a procedural change that enhances the process;
requesting and recording a stakeholder analysis that includes a score representative of a commitment of each of the plurality of personnel to implementing the procedural change;
identifying at least one stakeholder to lead implementing the procedural change based on the score of the stakeholder analysis; and
creating and implementing the procedural change to the process.

12. The system of claim 11, further comprising the acts of:
creating and displaying an initial value stream map including a measure of a cycle-time of each of a plurality of consecutive activities comprising the process; and
identifying the objective to reduce the cycle time of the plurality of consecutive activities of the initial value stream.

13. The system of claim 11, further comprising the act of bounding the objective, including identifying and displaying each of the plurality of consecutive activities that is within a boundary of the objective.

14. The system of claim 11, further comprising the act of requesting at least one stakeholder to communicate a visual display of the objective to the plurality of personnel.

15. The system of claim 11, wherein the act of creating the program includes:
identifying at least one root cause of the cycle time of the at least one of the plurality of consecutive activities within the objective, applying one or more lean tools to reduce the cycle time of the at least one of the plurality of consecutive activities within the objective, creating a program using the one or more lean tools to reduce the cycle time of the objective, and testing whether the program reduces the cycle time of the objective.

16. The system of claim 11, further comprising the act of:
communicating the program on a visual display to the plurality of personnel.

17. The system of claim 11, further comprising the acts of:
implementing the program in the process;
requesting at least one stakeholder to create a tracking program to verify a continuance of the act of implementing the program for illustration on a visual display; and
illustrating the visual management and display of the process tracking program.

18. The system of claim 17, wherein the tracking program includes a checklist, and further comprising the act of obtaining a signature of the at least one stakeholder on the checklist.

19. The system of claim 11, wherein the act of requesting at least one operational owner to identify at least one stakeholder includes identifying one or more of the plurality of personnel resistant to the objective so as to eliminate from being the at least one stakeholder.

20. The system of claim 11, further comprising the act of:
illustrating a name of the at least one stakeholder of the objective on a visual management and display to the plurality of personnel.
